(19) United States
(12) Patent Application Publication
(10) Pub. No.: US 2015/0014502 A1
(43) Pub. Date: Jan. 15, 2015

(54) Mounting Device for Mounting an Object to a Vehicle

(71) Applicant: Porteside Pty Ltd, Munster, Western Australia (AU)

(72) Inventor: Robert Archibald McCaughan, Munster (AU)

(73) Assignee: PORTESIDE PTY LTD, Munster, Western Australia (AU)

(21) Appl. No.: 14/371,521

(22) PCT Filed: Jan. 24, 2013
(86) PCT No.: PCT/AU2013/000048

§ 371 Date: Jul. 10, 2014

(30) Foreign Application Priority Data
Jan. 24, 2012 (AU) 2012900265

(51) Int. Cl. B60P 3/40; B62D 33/027; B60R 5/04

(52) U.S. Cl. CPC B60P 3/40; B60R 5/041; B62D 33/0273
USPC 248/229.2

(57) ABSTRACT

The present disclosure provides a mounting device for mounting an object to a vehicle. The vehicle has a tailgate and the mounting device comprises a mount for mounting the object to the mounting device. The mount comprises a rigid member on which the in use the object is mounted. Further, the mounting device comprises a coupling for coupling the mount to the tailgate of the vehicle. The coupling is arranged for removably coupling to the tailgate of the vehicle without requiring a structural modification of the tailgate.

### FIELD OF THE INVENTION

The present invention relates to a mounting device for mounting an object to a vehicle and relates particularly to a mounting device for mounting an object to a tailgate of a vehicle.

### BACKGROUND OF THE INVENTION

Pickup trucks and utility vehicles often have well-bodied load areas and it is often cumbersome to transport objects that have a length that is longer than that of the well-bodied load area. Permanent fixtures, such as ‘H’-shaped frames, are bolted onto such vehicles for commercial use to facilitate transportation of the long objects.

However, many pickup trucks and utility vehicles are frequently used privately as an alternative to a sedan-type car and consequently the appearance of such vehicles is often of importance. Further, it is often of advantage to maintain the vehicle in an original and unmodified state.

### SUMMARY OF THE INVENTION

The present invention provides in a first aspect a mounting device for mounting an object to a vehicle, the vehicle having a tailgate, the mounting device comprising:
a mount for mounting the object to the mounting device; the mount comprising a rigid member on which in use the object is mounted; and
a coupling for coupling the mount to the tailgate of the vehicle, the coupling being arranged for removably coupling to the tailgate of the vehicle without requiring a structural modification of the tailgate.

Throughout this specification the term “tailgate” is used for a flap, gate or any type of closure at the rear of the vehicle, such as a utility vehicle or pick-up truck having a well-bodied load area.

The mounting device in accordance with embodiments of the present invention has significant practical advantages. Transportation of objects that, for example, are longer than the load area of the vehicle is facilitated, as the load area is effectively extended and a mount for mounting the object is provided on the tailgate. Further, the mounting device is removable and does not require any structural modification to the tailgate, which has the advantage that the appearance of the vehicle is not disturbed by fixtures that are bolted onto the vehicle such as an H-shaped frame.

The mount may be arranged for positioning on an upward facing side of the tailgate when the tailgate is in a substantially horizontal position in which the tailgate opens a rearward portion of a load area of a vehicle having a well-bodied load area.

The present invention provides in a second aspect a mounting device for mounting an object to a vehicle, the vehicle having a tailgate, the mounting device comprising:
a mount for mounting the object to the mounting device; the mount being arranged for positioning on an upward facing side of the tailgate when the tailgate is in a substantially horizontal position in which the tailgate opens a rearward portion of a load area of a vehicle having a well-bodied load area; and
a coupling for coupling the mount to the tailgate of the vehicle, the coupling being arranged for removably coupling to the tailgate of the vehicle without requiring a structural modification of the tailgate.

The mount may comprise a rigid member on which in use the object is mounted.

The following introduces features that the mounting device, in accordance with either one the first and the second aspects of the present invention, may have.

The object may be of any suitable type and may for example be a leisure article, such as a bicycle or watercraft. Alternatively, the object may for example be building equipment, a tool box, a container, a work bench, a tool rack, a tray, building material or the like. Further, the object may be an electrical device, such as a power tool and may have an interface for coupling to a power supply.

The mount may comprise a holder for holding the object on the rigid member. Further, the rigid member may comprise at least one elongated recess for mounting the holder on the rigid member. The at least one elongated recess may be linear and may be a slot, rail or channel. For example, the mounting device may comprise one or more slots (such as 2 or more) that may be parallel and may have a substantially T-shaped cross-sectional shape. The at least one elongated recess may be oriented in a direction that is transversal to a driving direction of the vehicle.

The at least one recess may be arranged such that the holder is positionable at any one of a plurality of positions along a length of the at least one recess. The holder may be arranged for quick release and/or quick engagement. Further, the holder may comprise a power source and may be arranged for electrical coupling to the object, which in this example may be a power tool or the like. The holder may be controllable in a remote controlled and wireless manner and may be arranged for controlling a function of the object. In one example the holder is arranged for control by a handheld device, such as a smart phone.

The mounting device may also comprise signage, such as an electronic display that is in use positioned such that it is visible when the vehicle is driven. The signage may be electrically coupled to the holder and may be arranged for remote controlled operation in a wireless manner, such as by a handheld device that may be a smart phone.

The mounting device may be an articulated device that is arranged for surrounding at least a portion of the tailgate.

The mounting device may comprise flexible portions that allow wrapping of the mounting device around at least a portion of the tailgate. The mounting device may comprise rigid portions that are connected by hinges or flexure bearings and that are positioned such that the mounting device can be wrapped around at least a portion of a tailgate of the vehicle.

The mounting device may cover at least a portion of a front side, a top edge, a rear side and a bottom side of a tailgate of a vehicle.

The coupling may comprise first and second coupling portions that are positioned at first and second ends of the mounting device and are arranged such that, when the mounting device is wrapped around at least a portion of the tailgate, the first and second coupling portions are engageable with each other to secure the mounting device on the tailgate.

The coupling portions may be arranged such that their coupling positions are adjustable.

The coupling may comprise a clamp that is arranged to clamp the mounting device over the tailgate.

The mounting device may be suitable for mounting objects having a weight greater than 10 kg, 30 kg or 50 kg to the tailgate of the vehicle, within the safe limits of the tailgate in either horizontal or vertical positions.

The mounting device may comprise flexible portions that allow wrapping of the mounting device around at least a portion of the tailgate.

The mounting device may be at least partially composed of metal, plastic, vinyl, polyethylene, nylon, cotton, canvas, cloth, leather, paper, fibre, or any other suitable materials or combination of materials. For example, the mounting device may comprise a layer of neoprene that is positioned between the rigid member of the mount and the tailgate.

The present invention provides in a third aspect a method of mounting an object to a vehicle, the method comprising the steps of:
positioning a tailgate of the vehicle in a substantially horizontal position in which the tailgate opens a rearward portion of a load area of the vehicle having a well-bodied load area;
coupling a coupling of a mounting device to the tailgate, the coupling being arranged for removably coupling to the tailgate without requiring structural modification of the tailgate; and
mounting the object to a mount of the mounting device, the mount being positioned of an upward facing side of the tailgate.

The method may comprise using the mounting device in accordance with the first or second aspects of the present invention.

The invention will be more fully understood from the following description of specific embodiments of the invention. The description is provided with reference to the accompanying drawings.

### BRIEF DESCRIPTION OF THE DRAWINGS

FIGS. 1 to 6 are perspective views of a mounting device for mounting an object to a vehicle in accordance with an embodiments of the present invention; and

FIG. 7 is a flow chart illustrating a method of mounting an object to a vehicle in accordance with an embodiment of the present invention.

### DETAILED DESCRIPTION OF SPECIFIC EMBODIMENTS

Embodiments of the present invention relate to a mounting device for mounting an object to a tailgate of a vehicle.

The object may be of any suitable type and may for example be a leisure article, such as a bicycle or watercraft. Alternatively, the object may for example be building equipment, a tool box, a container, a work bench, a tool rack, a tray, building material or the like.

Vehicles having a tailgate such as utility vehicles and pick-up trucks typically have a well-bodied loading platform. When the tailgate is lowered to a position that is substantially horizontal (open), the tailgate is substantially coplanar with the loading platform which can accordingly be extended.

The mounting device is arranged for secure coupling to the tailgate without structurally modifying the tailgate of the vehicle. In accordance with some embodiments of the invention, the mounting device entirely covers portions of the tailgate of and consequently not only facilitates mounting an object to the vehicle, but also protects the tailgate.

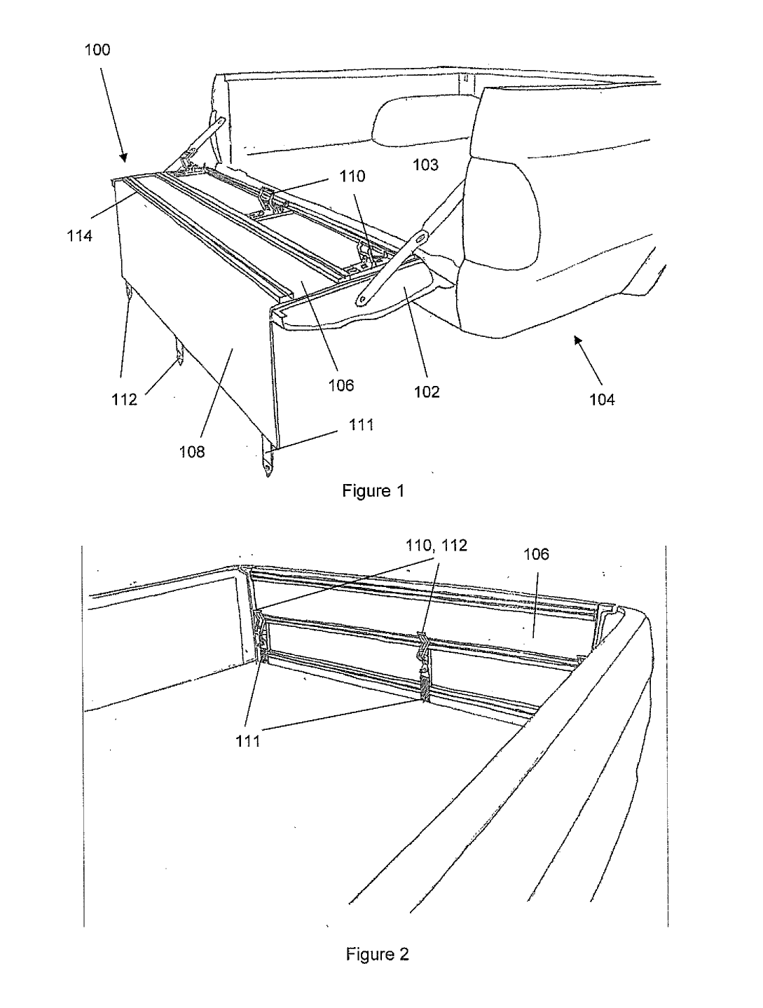

Referring now to FIG. 1, there is shown a mounting device 100 that is removably secured to a tailgate 102 of a vehicle 104. The mounting device 100 is secured to the tailgate 102 without requiring structural modification of the tailgate 102 or the vehicle 104.

In this particular example, the tailgate 102 of the vehicle 104 is shown in a lowered position that is substantially horizontal (open). The tailgate 102 may be raised into a raised position that is substantially vertical without the requirement of removing the mounting device 100 from the tailgate 102.

Depending on an object or a use of an object, the mounting device 100 may be arranged for use when the tailgate 102 is in a substantially horizontal (open) or in a substantially vertical (closed) position. Embodiments of the present invention may also include an arrangement (not shown) for assisting the tailgate movement between the horizontal and vertical position in a save manner. For example, the arrangement may comprise a suitable hydraulic strut or the like that provides a resistance when compressed or depressed.

In accordance with an embodiment of the invention, the mounting device 100 comprises flexible portions that facilitate wrapping the mounting device around the entire tailgate 102. The mounting device 100 may also comprise two or more rigid portions that are connected by hinges or flexure bearings to allow wrapping around the tailgate 102.

Referring back to FIG. 1 the mounting device 100 comprises a first portion 106 that is rigid and of a substantially rectangular shape. The first portion 106 entirely covers a surface of the tailgate 102 that is upwardly facing when in the horizontal (open) position.

The mounting device 100 further comprises a second portion 108 of a substantially rectangular shape which covers in use a surface of the tailgate 102 that is downwardly facing when the tailgate 102 is in the horizontal (open) position. A person skilled in the art will appreciate that other arrangements are envisaged. For example, the mounting device 100 may be of varying width to cover only a portion of a surface of the tailgate 102.

In this particular example, the mounting device 100 ‘saddles’ on the tailgate 102 and is wrapped around the tailgate 102. Suitable materials for the first portion 106 are, for example, metallic materials and plastics materials. The (rigid) first portion 106 and other portions of the mounting device may be covered with a soft material that is arranged to avoid damage to the tailgate 102 when the mounting device 100 is attached to the tailgate 102. For example, a layer of neoprene or material with similar properties (not shown) may be positioned between the first portion 106 and the tailgate 102, which facilities secure positioning of the first portion 106 on the tailgate 102. A person skilled in the art will appreciate that in an alternative embodiment (not shown) the entire first portion 106 may also be composed of a flexible material such as vinyl, nylon, cloth, leather, cotton, canvas, plastic, paper or the like.

The second portion 108 of the mounting device 100 is composed of a substantially flexible material. Such a suitable flexible material is vinyl, polyethylene, nylon, cotton, canvas, cloth, leather, paper, fibre, metallic material, or any other fabric of the like.

Having a portion that is composed of a flexible material has the advantage that the mounting device 100 can be wrapped around the tailgate 102 and the flexible material of the portion 108 can be adapted to suit different tailgate types and contours.

In one embodiment an upper surface below the rigid first portion 106 is covered with a material that is similar to that used for curtain-side trucks and the neoprene layer is positioned on the tailgate 102 at a bottom surface of the first part 106 forming a laminate material. When the mounting device 100 is tightened around the tailgate 102, the neoprene layer forms a shape that follows the profile of the tailgate 102, which increases the contact area with the tailgate 102.

The second portion 108 may have openings that allow access to a handle of the tailgate 102 (not shown). Further, signage or marketing messages may be applied to a portion of the mounting device 100. For example, the second portion 108 may comprise a signage mounting system such that signage or marketing messages can be exchanged.

In a further example, the first or second portion 106, 108 of the mounting device 100 comprises a display for displaying still or moving images (not shown). The display may be electrically coupled to the holder and may be arranged for remote controlled operation in a wireless manner, such as by a handheld device that may be a smart phone.

In this particular embodiment, the first and second portions 106, 108 of the mounting device 100 have a substantially identical shape and size. For example, the width of each portion 106, 108 may be half the width of the tailgate 102.

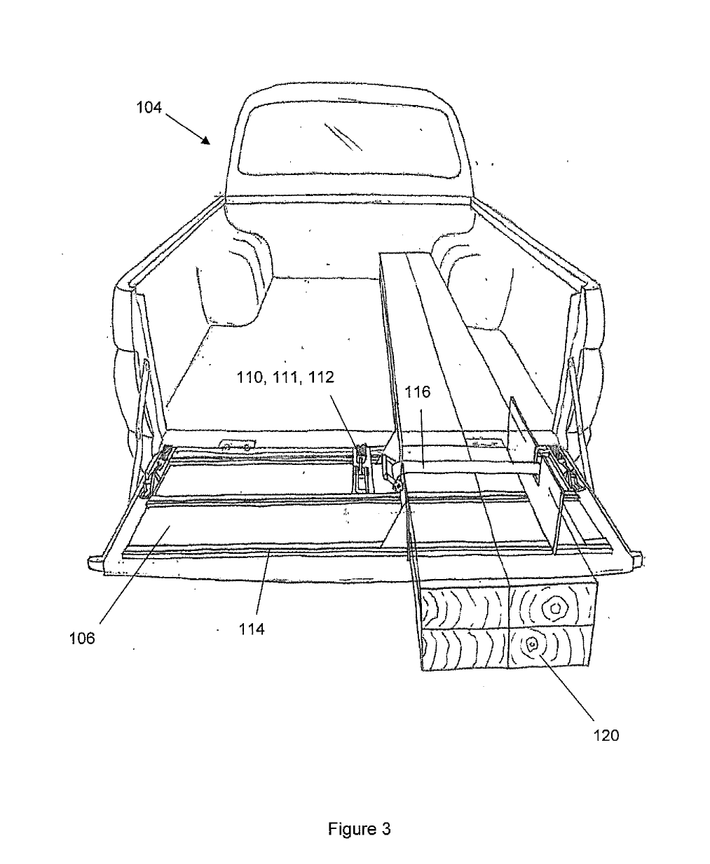

In order to secure the mounting device 100 to the tailgate 102, the first portion 106 further comprises eyelets 110 and the second portion 108 comprises straps 111 and catches 112 such that, when the mounting device 100 is wrapped around the tailgate 102, the eyelets 110 and the catches 112 can be securely engaged with each other as illustrated in FIG. 2.

A person skilled in the art will appreciate that the mounting device 100 can be secured to the tailgate 102 by other means, such as straps on first the and second portions 106, 108 of the mounting device. Other means may, for example, be links, ropes, cords, belts, webbing or the like.

The straps 111 or catches 112 may further comprise tightening means such that, when the mounting device 100 is wrapped around the tailgate 102, the mounting device 100 forms a tight and closed loop around the tailgate 102. A person skilled in the art will appreciate that other tightening means are envisaged.

In this particular example, three eyelets are located at one end of the first portion 106 and three catches 110 are located at one end of the portion 108 of the mounting device 100. When the mounting device 100 is wrapped around the tailgate 102 of the vehicle, the eyelets 110 and the catches 112 can be securely engaged with each other. Alternatively, any other suitable engagement arrangements may be used such as any type of male-female coupling. Examples for such couplings may be catches, hooks, interlocking loops, grommets, snaps, buttons and buttonholes, hook and eyes, cinch buckles, clip locking bucklers, ties, zippers or the like.

The mounting device 100 may comprise further suitable attaching means to secure the mounting device 100 to a side of the tailgate 102. Such an attaching means may, for example, be a clamp that is connected to a portion of the mounting device 100 and can be coupled to a side edge of the tailgate 102.

Referring back to FIG. 2, when the eyelets 110 and the straps 112 are securely engaged with each other, the tailgate 102 can be raised into the closed position in which the tailgate 102 is in a vertical position and closes the loading area of the vehicle.

In the embodiments shown in FIGS. 1 and 2, the first and second portions 106, 108, the eyelets 110, the straps 111 and the catches 112 form the coupling of the mounting device 100 for coupling an object to the tailgate 102 of the vehicle 104.

In another embodiment (not shown) the coupling of the mounting device 100 comprises portions that are composed of a rigid material and form a clamp. The clamp is arranged to form the coupling such that the mounting device 100 can securely clamp over the tailgate 102. In particular, the coupling may comprise two opposite portions of rectangular shape forming legs of the clamp.

Additionally or alternatively, the mounting device may comprise or may be composed of a magnetic material that couples to the ferrous metal of the tailgate. For example, the mounting device may comprise magnetic strips.

Referring now back to FIG. 1, the mounting device 100 comprises linear recesses that form slots 114 and that are arranged to mount one or more objects to the vehicle 104. In this embodiment the mounting device 100 comprises three parallel slots 114 having a substantially T-shaped cross-sectional shape. The eyelets 110 are securable in the three slots 114 at a plurality of positions distributed in a direction that is transversal to a driving direction such that the position of the eyelets 110 is selectable.

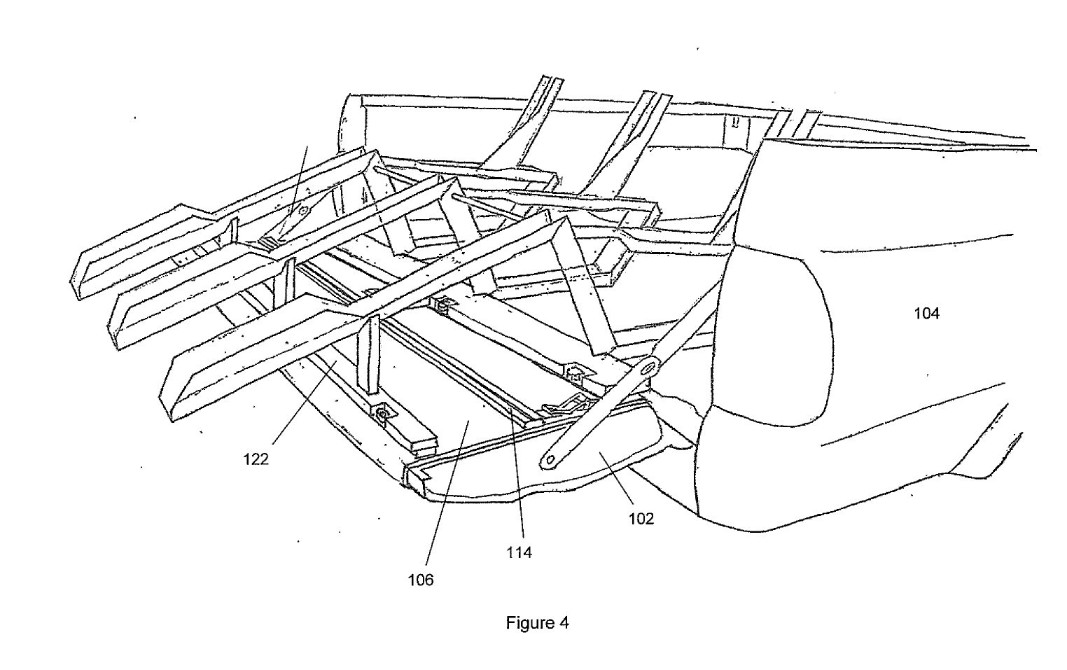

Referring now to FIG. 3, there is shown a rear view of the vehicle 104 having the tailgate 102 in the substantially horizontal (open) position. The mounting device 100 is wrapped around the tailgate 102 and secured as described above.

The slots 114 are arranged for mounting a holder for holding the object on the rigid first portion 106. In this particular example, a clamping device 116 is coupled to the slots 114. The clamping device 116 further comprises a belt in order to secure wooden planks 120 that are longer than the loading platform of the vehicle 104.

The mounting device 100 may further be provided with safety equipment, for example, signage or a flag to identify the size or length of the object.

Another example for mounting an object to the vehicle 104 is shown in FIG. 4. The tailgate 102 is in the substantially horizontal (open) position and the mounting device 100 is wrapped around the tailgate 102. On the slots 114, there is attached a bicycle rack 122 to the slots 114. With such an arrangement, bicycles can be securely transported by the vehicle 104. Further, the positions at which the bicycle rack 122 is secured in the slots 114 is selectable.

In an alternative example the bicycle rack 112 may be replaced by any other suitable type of holder, such as a quick release and/or quick engagement holder that may be arranged for manual, automatic and/or remote controlled operation. The holder may also comprise a power source and the object may be an electrical object (not shown), such as a power tool or the like. In this example the holder may be controllable by a handheld device, such as a smart phone and may effect control of the electrical device that is held by the holder.

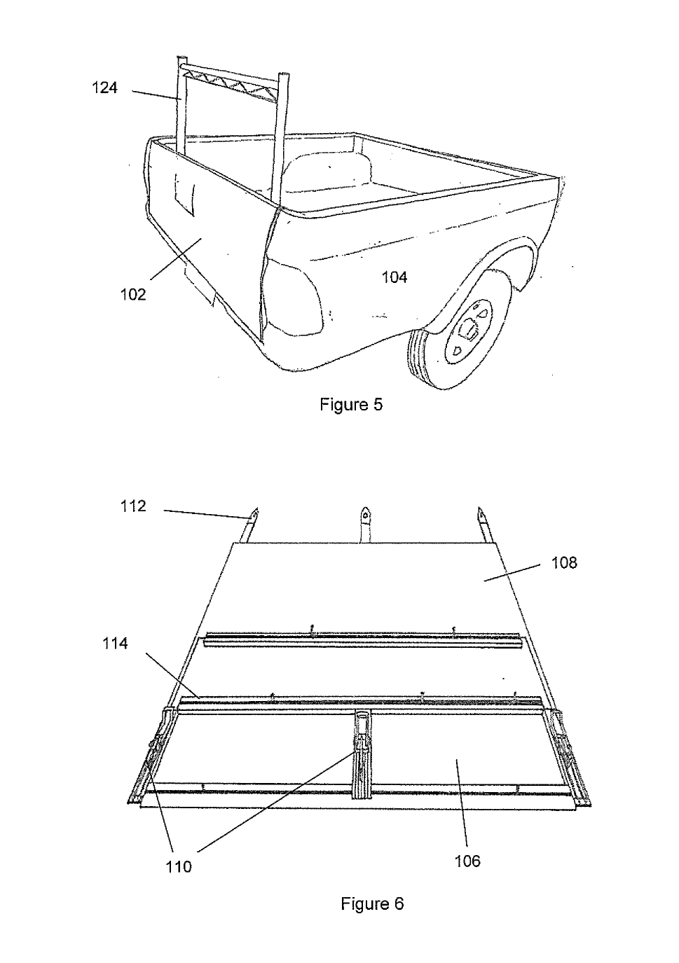

A further example for mounting an object to the vehicle 104 is shown in FIG. 5. In this example, the tailgate 102 is in a substantially vertical (closed) position and a frame 124 is attached to the mounting device 100. By mounting an object to the frame 124, additional space or usage of the loading area of the vehicle may be provided.

FIG. 6 illustrates how the mounting device 100 may be arranged for storage. The mounting device 100 may form a flat sheet, which is particularly advantageous for storing, for example, on the bottom of the loading area of the vehicle 104 or by hanging the mounting device 100 onto a wall. The mounting device 100 may also be foldable for the ease of storage.

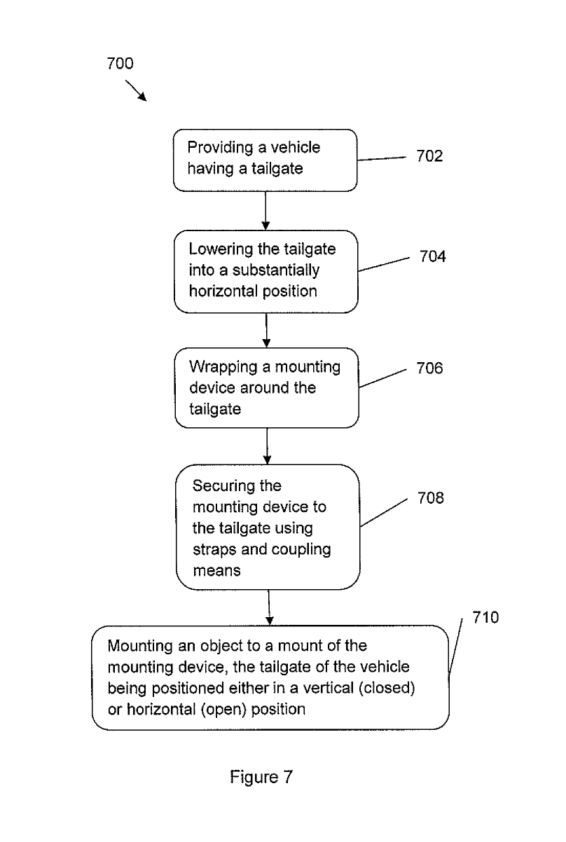

FIG. 7 illustrates a flow diagram of a method 700 of mounting an object to a vehicle in accordance with an embodiment of the present invention.

In a first step 702, a vehicle is provided having a tailgate. Such a vehicle typically has a well-bodied load area of a particular size.

In order to mount a mounting device to the tailgate of the vehicle, the tailgate is lowered into a substantially horizontal (open) position in step 704. The mounting device can be mounted onto the tailgate without performing structural modifications on the tailgate or the vehicle.

In subsequent steps 706, 708, the mounting device is wrapped around the tailgate and is further secured using straps and coupling means at opposing ends of the mounting device to form a tight loop around the tailgate.

The mounting device further comprises at least one mount, onto which in step 710, an object is mounted. Before or after mounting the object to the mount, the tailgate may be raised into a substantially vertical (closed) position depending on the object or use of the object.

Although the invention has been described with reference to particular examples, it will be appreciated by those skilled in the art that the invention may be embodied in many other forms.

1. A mounting device for mounting an object to a vehicle, the vehicle having a tailgate, the mounting device comprising:
a mount for mounting the object to the mounting device; the mount comprising a rigid member on which in use the object is mounted; and
a coupling for coupling the mount to the tailgate of the vehicle, the coupling being arranged for removably coupling to the tailgate of the vehicle without requiring a structural modification of the tailgate.

2. The mounting device of claim 1 wherein the mount is arranged for positioning on an upward facing side of the tailgate when the tailgate is in a substantially horizontal position in which the tailgate opens a rearward portion of a load area of a vehicle having a well-bodied load area.

3. A mounting device for mounting an object to a vehicle, the vehicle having a tailgate, the mounting device comprising:
a mount for mounting the object to the mounting device; the mount being arranged for positioning on an upward facing side of the tailgate when the tailgate is in a substantially horizontal position in which the tailgate opens a rearward portion of a load area of a vehicle having a well-bodied load area; and
a coupling for coupling the mount to the tailgate of the vehicle, the coupling being arranged for removably coupling to the tailgate of the vehicle without requiring a structural modification of the tailgate.

4. The mounting device of claim 3 wherein the mount comprises a rigid member on which in use the object is mounted.

5. The mounting device of claim 1 4 wherein the mount comprises a holder for holding the object and at least one elongated recess for securing the holder on the rigid member.

6. (canceled)

7. (canceled)

8. (canceled)

9. (canceled)

10. (canceled)

11. (canceled)

12. The mount of claim 5 wherein at least one elongated recess is oriented in a direction that is transversal to a driving direction of the vehicle.

13. The mounting device of claim 5 wherein the holder is arranged for quick release and/or quick engagement.

14. The mounting device of claim 1 wherein the mounting device is an articulated device that is arranged for surrounding at least a portion of the tailgate.

15. The mounting device of claim 1 comprising rigid portions that are connected by hinges or flexure bearings and that are positioned such that the mounting device can be wrapped around at least a portion of the tailgate.

16. The mounting device of claim 1 wherein the mounting device covers at least a portion of a front side, a top edge, a rear side and a bottom side of a tailgate of a vehicle.

17. The mounting device of claim 1 comprising flexible portions that allow wrapping of the mounting device around at least a portion of the tailgate.

18. The mounting device of claim 1 wherein the coupling comprises first and second coupling portions that are positioned at first and second ends of the mounting device and are arranged such that, when the mounting device is wrapped around at least a portion of the tailgate, the first and second coupling portions are engageable with each other to secure the mounting device on the tailgate.

19. (canceled)

20. The mounting device of claim 1 wherein the coupling comprises a clamp that is arranged to clamp the mounting device over the tailgate.

21. (canceled)

22. (canceled)

23. (canceled)

24. A method of mounting an object to a vehicle, the method comprising the steps of:
positioning a tailgate of the vehicle in a substantially horizontal position in which the tailgate opens a rearward portion of a load area of the vehicle having a well-bodied load area;
coupling a coupling of a mounting device to the tailgate, the coupling being arranged for removably coupling to the tailgate without requiring structural modification of the tailgate; and
mounting the object to a mount of the mounting device, the mount being positioned of an upward facing side of the tailgate.

25. The method of claim 24 wherein mounting the object comprises mounting the object using a holder and securing the holder along one or more rails or slots.

26. (canceled)

27. The method of claim 24 comprising using the mounting device in accordance with claim 1.

28. (canceled)

29. (canceled)

30. (canceled)

31. (canceled)

32. The mounting device of claim 1 wherein the holder comprises a power source and is arranged for electrical coupling to an electrical device that is the object.

33. (canceled)

34. The mounting device of claim 32 wherein the holder is controllable in a remote controlled and wireless manner.

35. The mounting device as claimed in claims 32 wherein the holder is arranged for controlling a function of the object and wherein the holder is arranged for control by a handheld device.

36. The mounting device of claim 1 comprising an electronic display that is in use positioned such that it is visible when the vehicle is driven.

37. (canceled)
